(19) United States
(12) Patent Application Publication
(10) Pub. No.: US 2011/0038407 A1
(43) Pub. Date: Feb. 17, 2011

(54) Equalizer receiver in a mobile communication system and method therefor

(75) Inventors: Young-Min Ki, Suwon-si (KR); Kwang-Man Ok, Hwaseong-si (KR); Seong-Wook Song, Gwacheon-si (KR); Seung-Hwan Won, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/806,367

(22) Filed: Aug. 11, 2010

(30) Foreign Application Priority Data
Aug. 17, 2009 (KR) 10-2009-0075783

(51) Int. Cl. H04L 27/01

(52) U.S. Cl. 375/232

(57) ABSTRACT

A method for receiving a signal using an equalizer receiver in a mobile communication system includes matched-filtering a signal received via an antenna. The method also includes generating different phase information for a serving cell and one or more other cells. The method further includes generating Pseudo-random Noise (PN) codes for the cells based on the phase information; estimating channel estimation values for the cells using the PN codes and the filtered signal; modeling random sequences similar in statistical property to signals transmitted from the cells using the channel estimation values, and generating a filter coefficient using the modeled random sequences; and equalizing the filtered signal using the filter coefficient. By doing so, the receiver's channel estimation performance and equalizer adaptation performance may be maximized.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Aug. 17, 2009 and assigned Serial No. 10-2009-0075783, the entire disclosure of which is hereby incorporated by reference.

### TECHNICAL FIELD OF THE INVENTION

The present invention relates generally to a receiver structure and a reception method in a mobile communication system, and more particularly, to a receiver structure and a reception method using interference cancellation and an equalizer.

### BACKGROUND OF THE INVENTION

With the standardization and commercialization of high-speed mobile communication systems requiring high-speed data transmission, such as Wideband Code Division Multiple Access (WCDMA) and High Speed Downlink Packet Access (HSDPA), a variety of equalizer-based receivers suitable for high-speed data reception have been studied, and a typical example thereof may include a receiver using a linear equalizer, a linear-feedback equalizer, or the like.

The linear equalizer includes a linear filter for maximizing a Signal-to-Interference Ratio (SIR) of a demodulated signal. The linear equalizer provides superior performance than a rake receiver, but it is complex in structure and high in power consumption compared with the rake receiver. However, since a receiver using a rake receiver has a limitation on high-speed data reception, the linear equalizer providing superior performance is usually adopted for a receiver.

However, the conventional linear equalizer uses an adaptive equalizer algorithm that calculates an optimal filter using the existing signal without estimating channel or noise power. Hence, in the situation where the channel state changes frequently, it is difficult for the linear equalizer using the adaptive equalizer algorithm to rapidly obtain the optimal filter coefficient.

### SUMMARY OF THE INVENTION

To address the above-discussed deficiencies of the prior art, it is a primary object to provide at least the advantages described below. Accordingly, an aspect of the present invention is to provide a receiver device and method for obtaining an optimal filter coefficient using an adaptive equalizer algorithm in a situation where a channel state changes frequently.

Another aspect of the present invention is to provide a receiver device and method capable of overcoming degradation of an adaptive equalizer due to the limit of channel estimation in a single-cell environment.

A further aspect of the present invention is to provide a receiver device and method in which, in order to overcome the main causes of the performance degradation, equalizer performance is improved through more accurate signal modeling and interference signal cancellation in a multi-cell reception environment.

Yet another aspect of the present invention is to provide a receiver device and method for improving receiver performance by cancelling interference signals in a multi-cell signaling environment, and maximizing the receiver performance if necessary.

Still another aspect of the present invention is to provide a receiver device and method for adaptively activating/inactivating multi-cell equalizer adaptation and reference signal interference cancellation functions, and estimating the exact operation phases and edges of multiple cells.

In accordance with one aspect of the present invention, there is provided a method for receiving a signal using an equalizer receiver in a mobile communication system. The method includes matched-filtering a signal received via an antenna; generating different phase information for a serving cell and one or more other cells; generating Pseudo-random Noise (PN) codes for the cells based on the phase information; estimating channel estimation values for the cells using the PN codes and the filtered signal; modeling random sequences similar in statistical property to signals transmitted from the cells using the channel estimation values, and generating a filter coefficient using the modeled random sequences; and equalizing the filtered signal using the filter coefficient.

In accordance with another aspect of the present invention, there is provided an equalizer receiver that can receive a signal in a mobile communication system, including a matched filter that can matched-filter a signal received via an antenna; a control unit that can generate different phase information for a serving cell and one or more other cells; a multi-cell Pseudo-random Noise (PN) generator that can generate PN codes for the cells based on the phase information; a multi-cell channel estimator that can estimate channel estimation values for the cells using the PN codes and the filtered signal; a multi-cell adaptive equalizer that can model random sequences similar in statistical property to signals transmitted from the cells using the channel estimation values, and generate a filter coefficient using the modeled random sequences; and an equalizer Finite Impulse Response (FIR) filter that can equalize the filtered signal using the filter coefficient.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure and signal flow of a channel estimator and an equalizer receiver according to embodiments of the present disclosure;

FIG. 2 illustrates a structure and signal flow of a multi-tap channel estimator according to embodiments of the present disclosure;

FIG. 3 illustrates a structure and signal flow of an SRE-LMS equalizer adaptation unit according to embodiments of the present disclosure;

FIG. 4 illustrates a structure and signal flow of a multi-cell SRE-LMS equalizer receiver according to embodiments of the present disclosure;

FIG. 5 illustrates a structure and signal flow of a multi-cell channel estimator according to embodiments of the present disclosure;

FIG. 6 illustrates a structure and signal flow of a multi-cell SRE-LMS equalizer adaptation unit according to embodiments of the present disclosure;

FIG. 7 illustrates a structure and signal flow of a multi-cell reference signal interference cancellation SRE-LMS equalizer receiver according to embodiments of the present disclosure;

FIG. 8 illustrates a structure and signal flow of a multi-cell reference signal interference cancellation unit according to embodiments of the present disclosure;

FIG. 9 illustrates a structure and signal flow of an iterative multi-cell reference signal interference cancellation SRE-LMS equalizer receiver according to embodiments of the present disclosure;

FIG. 10 illustrates a structure and signal flow of a signal memory and a re-adder according to embodiments of the present disclosure;

FIG. 11 illustrates a structure and signal flow of a channel estimator selector according to embodiments of the present disclosure;

FIG. 12 illustrates a structure and signal flow of a chip buffer selector according to embodiments of the present disclosure;

FIG. 13 illustrates a structure and signal flow of an iterative multi-cell timing & interference canceller control unit according to embodiments of the present disclosure;

FIG. 14 illustrates an operation of a multi-cell SRE-LMS equalizer receiver according to embodiments of the present disclosure;

FIG. 15 illustrates an operation of a multi-cell reference signal interference cancellation SRE-LMS equalizer receiver according to embodiments of the present disclosure; and

FIG. 16 illustrates an operation of an iterative multi-cell reference signal interference cancellation SRE-LMS equalizer receiver according to embodiments of the present disclosure.

Throughout the drawings, the same drawing reference numerals will be understood to refer to the same elements, features and structures.

### DETAILED DESCRIPTION OF THE INVENTION

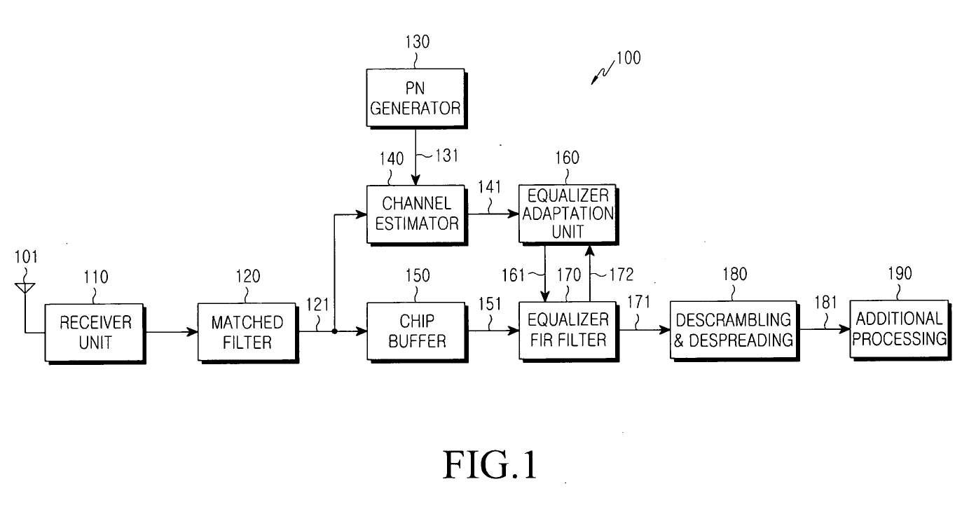

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system. Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

FIG. 1 illustrates an equalizer-based mobile communication receiver using a channel estimator according to an embodiment of the present invention.

A received signal of the mobile communication receiver becomes a data signal 121 after passing through a receive antenna 101, a receiver unit 110 and a matched filter 120.

The data signal 121 is branched to a channel estimator 140 and a chip buffer 150. The channel estimator 140 generates a multi-tap channel estimation value 141 using the data signal 121 and a Pseudo-random Noise (PN) signal 131 generated by a PN generator 130, and provides the channel estimation value 141 to an equalizer adaptation unit 160.

The equalizer adaptation unit 160, a circuit comprised of an algorithm such as Linear Minimum Mean Square Error (LMMSE) and Least Mean Square (LMS), generates a filter coefficient 161 to be used for an equalizer Finite Impulse Response (FIR) filter 170.

The equalizer FIR filter 170 performs equalization using the filter coefficient 161 and a signal 151 which has been stored in and received from the chip buffer 150. The equalized signal 171 is restored to an information signal after undergoing descrambling & despreading 180 and additional processing 190.

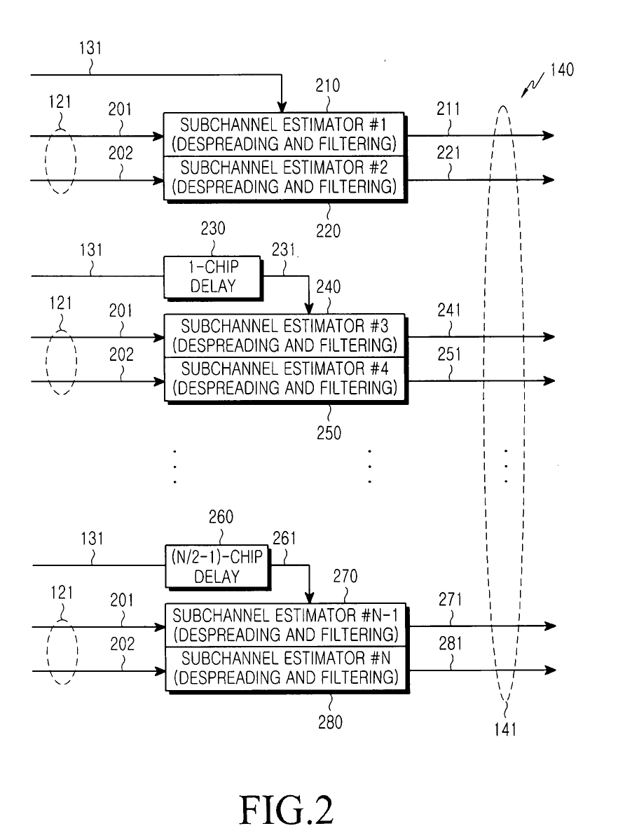

FIG. 2 illustrates a detailed structure of a multi-tap channel estimator according to an embodiment of the present invention, in which the channel estimator has N continuous taps.

Each tap has a delay time of a half chip. Reference numerals 201 and 202 represent input data signals from the matched filter 120. To be specific, reference numerals 201 and 202 indicate an on-sample and a half-chip late-sample, respectively.

Each of sub-channel estimators 210, 220, 240, 250, 270 and 280 receives the PN signal 131 from the PN generator 130, along with the input data signals 121, and outputs the channel estimation values 141 by performing despreading and noise filtering.

Among N sub-channel estimators, two continuous sub-channel estimators perform channel estimation on an on-sample and a late-sample, respectively. Herein, N is the number of continuous taps that the channel estimator 140 can estimate, and is consistent even with the number of taps of the equalizer FIR filter 170. Thus, N continuous channel estimations may be performed at half-chip intervals by providing a chip delay (230 or 260) to every two sub-channel estimators. Reference numerals 211, 221, 241, 251, 271 and 281 represent channel estimation values of associated sub-channel estimators, respectively, and they are provided to the equalizer adaptation unit 160.

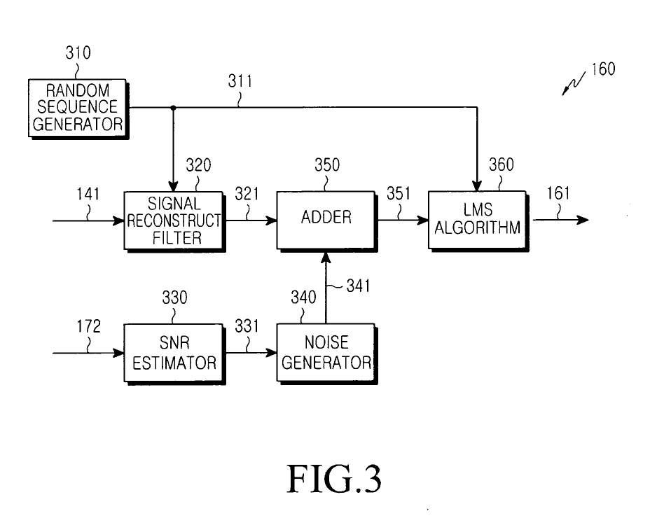

FIG. 3 illustrates a structure of a single-cell equalizer adaptation unit using a Signal Reconstruct Least Mean Square (SRE-LMS) algorithm.

The SRE-LMS equalizer adaptation unit includes a random sequence generator 310, a signal reconstruct filter 320, a Signal to Noise Ratio (SNR) estimator 330, a noise generator 340, an adder 350, and an LMS algorithm 360.

The random sequence generator 310 generates a random sequence 311, which is similar in statistical property to a transmission signal of a base station.

The signal reconstruct filter 320 generates a random sequence 321, which is similar in statistical property to a received signal of a terminal, through filtering between the multi-tap channel estimation value 141 and the random sequence 311.

The term “statistical property” as used herein may refer to a mean or a variance of a signal sequence.

The SNR estimator 330 receives an equalized signal 172 from the equalizer FIR filter 170, estimates an SNR, and then provides the estimated SNR to the noise generator 340. The noise generator 340 generates a noise signal 341 based on the estimated SNR. The SNR estimator 330 and the noise generator 340 model noises with Additive White Gaussian Noise (AWGN), and this is to improve convergence performance of the LMS algorithm by artificially generating a noise signal and applying the nose signal to the LMS algorithm 360 in order to consider the noise and interference components that the signal reconstruct filter 320 cannot model.

The adder 350 adds the random sequence 321 and the noise signal 341, and provides the added signal to the LMS algorithm 360.

Through such methods, the LMS algorithm 360 adaptively filters a random sequence 351 which is similar in statistical property to a received signal of a terminal, referring to the random sequence 311, which is similar in statistical property to a transmission signal of a base station, thereby generating optimal equalizer tap coefficients 161 to be used in the equalizer FIR filter 170.

A receiver using the channel estimator 140 and the equalizer of the present invention can use, as its basic structure, a method of statistically modeling a transmission signal and a received signal for a signal of a cell (i.e., serving cell or own cell) from which a terminal is receiving a service, and calculating an equalizer tap coefficient using the modeled two random sequences (i.e., the transmission signal and the received signal).

Noise and interference characteristics may be reflected in the manner of generating and applying a noise signal modeled with SNR estimation and AWGN. However, this method can be limited in modeling noise and interference signals in an environment where multi-cell received signals and non-orthogonal signal noises are received, because it models the terminal's receiving environment only with the single-cell signal and AWGN.

Since a receiving terminal receives only the transmission signal of the serving cell's base station and the noises having a relatively low strength in an area where serving cell's signals are high in strength, such as the cell center, modeling is possible only with AWGN, assuming it is a single-cell signaling environment. However, in an environment (e.g., cell edge) where signals from other cells or non-serving cells (or interfering cells), which are not relatively low in strength, are received, it cannot be considered that statistical property of the other cell's signal (or an interfering cell's signal) is the same as that of AWGN. Accordingly, the AWGN signal modeling based on the single-cell signaling environment is not sufficient to reflect the cell edge's environments, possibly causing degradation of equalizer performance.

In a system such as WCDMA and High Speed Packet Access (HSPA), as a base station transmits signals by spreading them with an orthogonal code specific to each channel, a terminal may cancel inter-channel interference by despreading received signals with the orthogonal code. However, since a Synchronization Channel (SCH) used in WCDMA and HSPA is not spread with an orthogonal code, it is received as a non-orthogonal interference signal without being removed in a despreading process of the terminal. In addition, although the other cell's signal has been spread with a scrambling code and an orthogonal code different from those of the serving cell's signal, since it is not consistent in code phase with the serving cell's signal, the other cell's signal is not canceled even though it undergoes the despreading process of the receiver. As a result, due to correlation property of the spreading code, the other cell's signal is received as interference, power of which is less than that of the serving cell's signal. In other words, in the multi-cell reception environment, non-orthogonal signal interference is received, which is caused by the serving cell's SCH and the other cell's signal.

Statistical property of the non-orthogonal signal interference is not consistent with that of AWGN signal modeling used in the prior art, thus possibly causing degradation of equalizer performance in an environment where the non-orthogonal signal interference is received.

The main reason why the use of the conventional receiver degrades received signals in the environment where multi-cell signals are received, is that because a statistical random sequence used in an equalizer adaptation process includes only the serving cell's signal, not the other cells' signals, the equalizer tap coefficient converged by the LMS algorithm is not suitable for the multi-cell reception environment and a data signal to be used for restoration of information signals after passing through an equalizer FIR filter includes the intact non-orthogonal interference signals.

A receiver method for more accurate signal modeling and interference signal cancellation in the multi-cell reception environment principally includes a multi-cell equalizer adaptation and multi-cell reference signal interference cancellation operation and an iterative multi-cell equalization and reference signal interference cancellation operation.

The multi-cell equalizer adaptation is a process for allowing the LMS algorithm to converge an equalizer FIR filter's tap coefficient suitable to the multi-cell reception environment through accurate modeling for multi-cell received signals. The multi-cell reference signal interference cancellation is a process of avoiding performance degradation of received signals by reconstructing a multi-cell reference signal and removing it from the data signal in a physical layer, the multi-cell reference signal acting as interference because its orthogonality is not maintained despite the despreading process of the receiver.

The present invention proposes a receiver with a multi-cell adaptive equalizer in the multi-cell signaling environment. The receiver with a multi-cell adaptive equalizer adopts, as a basic principle, a method of operating an adaptive equalization algorithm by statistically modeling both transmission signals and received signals for each cell in the multi-cell reception environment.

To improve performance against the non-orthogonal signal interference, the present invention proposes a multi-cell reference signal interference cancellation structure. The multi-cell reference signal interference cancellation may cancel interference signals such as a Common Pilot Channel (CPICH) and an SCH, which can be reconstructed in the physical layer, among the serving cell's signals with no orthogonal property, such as SCH, and the other cells' signals. In addition, an iterative equalizer adaptation and interference cancellation method is applied.

An equalizer-based receiver according to an embodiment of the present invention includes a channel estimator and an adaptive equalizer using the same. The channel estimator includes a tap sufficiently long to receive all of received signal's delay profiles that have experienced multi-path signals, and the adaptive equalizer uses multi-tap channel values estimated by the channel estimator.

While it is assumed in a detailed description of the present invention that an SRE-LMS equalizer receiver is used as an equalizer receiver, it should be apparent to those skilled in the art that the present invention is not limited to the SRE-LMS algorithm and may be applied to any receivers using an adaptive equalizer.

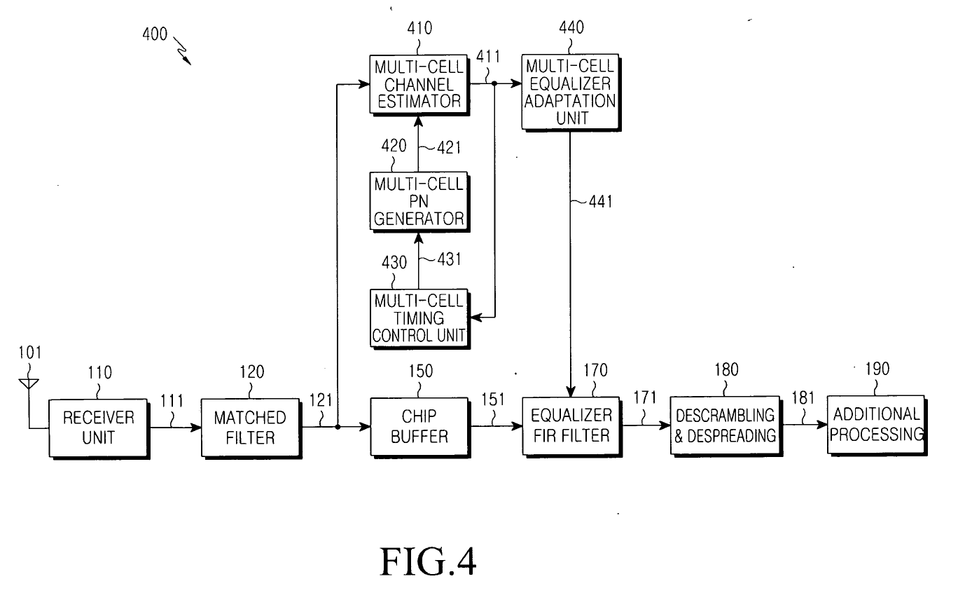

FIG. 4 illustrates a structure of a multi-cell SRE-LMS equalizer receiver (or an equalizer receiver with multi-cell SRE-LMS) according to an embodiment of the present invention.

The multi-cell SRE-LMS equalizer receiver 400 of FIG. 4 is different from the equalizer-based receiver 100 of FIG. 1 in that a multi-cell channel estimator 410, a multi-cell PN generator 420 and a multi-cell equalizer adaptation unit 440 are modified and a multi-cell timing control unit 430 for controlling these modified units is added.

The multi-cell SRE-LMS equalizer receiver, like the equalizer-based receiver of FIG. 1, branches an output data signal 121 of the matched filter 120 to the chip buffer 150 and the multi-cell channel estimator 410.

The multi-cell channel estimator 410 is a circuit capable of performing channel estimation for the serving cell and several other cells. Channel estimation for each cell includes channel estimation for N continuous taps. To perform channel estimation for several cells, the multi-cell channel estimator 410 should be able to demodulate a pilot channel of each cell. To this end, the multi-cell PN generator 420 is needed, which can generate a PN code specific to each cell. The PN code specific to each cell may be acquired from system information or a control channel signal transmitted from the serving cell's base station.

The multi-cell timing control unit 430, a circuit for managing a PN phase of each cell signal, generates each cell's phase information 431 needed for channel estimation, and outputs it to the multi-cell PN generator 420. The phase information 431 of each cell is used to generate a PN code specific to each cell.

The multi-cell equalizer adaptation unit 440 generates an equalizer FIR filter's tap coefficient 441 using a multi-cell channel estimation value 411 received from the multi-cell estimator 410, and provides the generated coefficient to the equalizer FIR filter 170. A signal data restoration process after the equalizer FIR filter 170 is the same as that of FIG. 1.

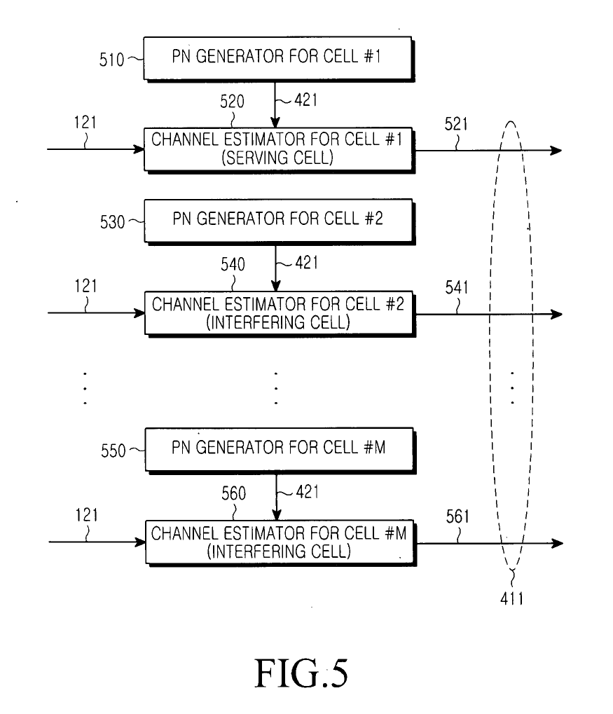

FIG. 5 illustrates a detailed structure of a multi-cell channel estimator 410 and a multi-cell PN generator 420 according to an embodiment of the present invention.

The multi-cell channel estimator 410 is a circuit for performing channel estimation for M cells, wherein M denotes the number of cells, from which a receiver can receive signals and check information about the cells, including the serving cell (or own cell) and interfering cells (or non-serving cells). In other words, M indicates the number of all cells, reference signals from which the receiver can restore.

A first-cell PN generator (or a PN generator for a first cell) 510 and a first-cell channel estimator (or a channel estimator for a first cell) 520, constituting a multi-tap channel estimator for a serving cell, are equivalent in internal structure to the PN generator 130 and the channel estimator 140 of FIG. 1.

The first-cell channel estimator 520 receives an input 121 from the matched filter 120, and generates a channel estimation value 521 for N continuous taps. A second-cell PN generator (or a PN generator for a second cell) 530 and a second-cell channel estimator (or a channel estimator for a second cell) 540 perform channel estimation for the second cell, which is an interfering cell, and then output an N-tap channel estimation value 541. In the same manner, an M-th-cell PN generator (or a PN generator for an M-th cell) 550 and an M-th-cell channel estimator (or a channel estimator for an M-th cell) 560 perform channel estimation for the M-th cell, which is also an interfering cell, and then output an N-tap channel estimation value 561. The multi-cell multi-tap channel estimation values 521, 541 and 561 are input (411) to the multi-cell equalizer adaptation unit 440.

The receiver with a multi-cell adaptive equalizer according to an embodiment of the present invention may be realized, if there are only two different types of information: Identifier (ID) and timing boundary information of a cell-specific PN code. This is related to the fact that a cell-specific PN generator is present for every cell. Since a unique PN code should be generated for each cell due to the uniqueness of the cell-specific PN code's ID and the unique offset of the cell-specific transmission delay time (transmission offset), a PN generator should be present for each cell. The timing boundary represents an offset of the cell-specific transmission delay time.

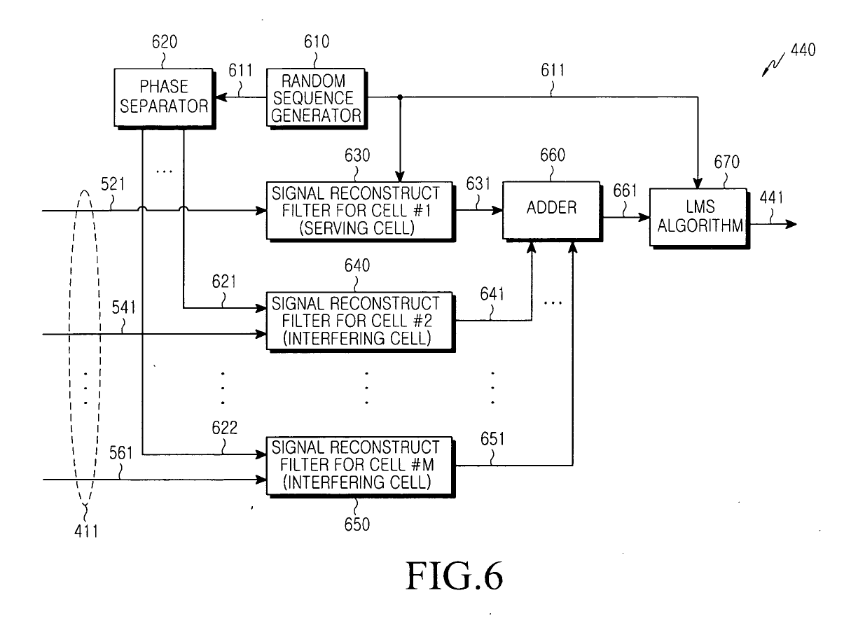

FIG. 6 illustrates a detailed structure of a multi-cell SRE-LMS equalizer adaptation unit (or a multi-cell equalizer adaptation with SRE-LMS algorithm) 440 according to an embodiment of the present invention.

A random sequence generator 610 and a first-cell signal reconstruct filter (or a signal reconstruct filter for a first cell) 630 may be considered as the same circuits as the random sequence generator 310 and the signal reconstruct filter 320 in FIG. 3. In other words, the random sequence generator 610 the first-cell signal reconstruct filter 630 receive the multi-tap channel estimation value 521 for the serving cell, set it as an FIR filter's tap coefficient, and then generate and provide a statistical random sequence 631 by filtering a random sequence 611. As a result, the random sequence 611 becomes a random sequence similar in statistical property to the transmission signal of the serving cell's base station, while the random sequence 631 becomes a random sequence similar in statistical property to the signal received at the terminal from the serving cell's base station.

It should be apparent to those skilled in the art that the term “reconstruct” as used herein refers to a process of making or reconstructing a signal to be similar to an actual signal in the receiver, rather than re-generating a signal.

A phase separator 620 is a circuit for receiving the random sequence 611 from the random sequence generator 610 and generating M−1 random sequences, which are different in phase from the random sequence 611. For example, the random sequence generator 610 may consist of a memory in which +1 or −1 of 2048 length are stored at random. In this case, the phase separator 620 outputs the sequence 611 for modeling the serving cell's transmission signal as a random sequence having a phase of 0, outputs a sequence 621 for modeling a second cell's transmission signal as a random sequence having a phase of 512, and outputs a sequence 622 for modeling an M-th cell's transmission signal as a random sequence having a phase of 1024, thereby making it possible to model several random sequences which are the same in statistical property.

A second-cell signal reconstruct filter (or a signal reconstruct filter for a second cell) 640 receives the multi-tap channel estimation value 541 of the second cell, sets it as an FIR filter's tap coefficient, and then generates and provides a statistical random sequence 641 by filtering the random sequence 621. In the same manner, an M-th-cell signal reconstruct filter (or a signal reconstruct filter for an M-th cell) 650 receives the multi-tap channel estimation value 561 of the M-th cell, sets it as an FIR filter's tap coefficient, and then generates and provides a statistical random sequence 651 by filtering the random sequence 622. The random sequences 641 and 651 are, respectively, random sequences obtained by modeling random sequences similar in statistical property to the signals, which have been transmitted from the second and M-th cells, or non-serving cells (i.e., interfering cells), and then received at the terminal.

An adder 660 adds the statistical random sequences, and provides the result to an LMS algorithm 670. As a result, the added signal 661 becomes a random sequence similar in statistical property to multi-cell received signals, which is obtained by modeling all of the signals received from the respective cells in the multi-cell reception environment.

The LMS algorithm 670 calculates a tap coefficient of the equalizer FIR filter 170 using the signal 661 similar in statistical property to the multi-cell received signals, referring to the serving cell's random sequence 611.

In summary, the multi-cell equalizer adaptation unit 440 according to the present invention performs channel estimation for all cells, reference signals from which a receiving terminal can restore and receive, and adds statistical random sequences generated respectively with the estimated multi-cell channel estimation values, thereby making it possible to model a signal identical in statistical property to the multi-cell received signals. Meanwhile, strength of a received signal from each cell has already been reflected in each of multi-cell channel estimation values, and thus, reflected in generating the statistical random sequences.

Meanwhile, the multi-cell equalizer adaptation unit 440 is superior in complexity compared with a direct computation-based linear equalization scheme like the LMMSE scheme, since only the primary FIR filter structure in the physical layer is modified. In addition, through experiments, the throughput of the multi-cell equalizer adaptation unit 440 showed a gain of 10% to 300% compared with when the equalizer adaptation unit was applied in the single-cell environment.

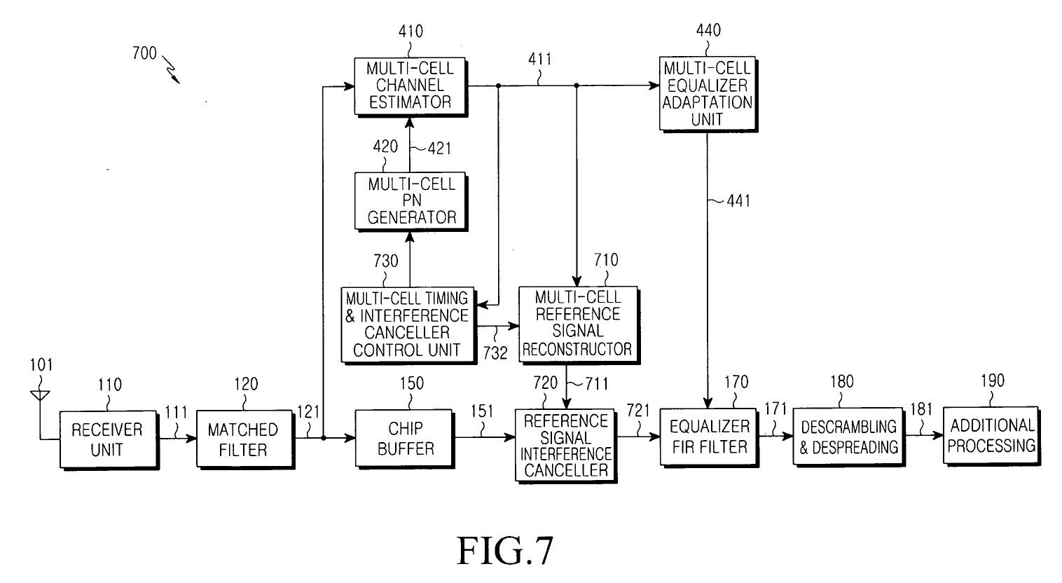

FIG. 7 illustrates a structure of a multi-cell reference signal interference cancellation SRE-LMS equalizer receiver (or an equalizer receiver with multi-cell SRE-LMS and reference signal cancellation) according to an embodiment of the present invention.

The multi-cell reference signal interference cancellation SRE-LMS equalizer receiver of FIG. 7 is different from the multi-cell SRE-LMS equalizer receiver of FIG. 4 in that a multi-cell reference signal reconstructor 710 and a reference signal interference canceller 720 are added, and a multi-cell timing & interference canceller control unit 730 is modified.

The multi-cell reference signal interference cancellation SRE-LMS equalizer receiver of FIG. 7 is the same as the multi-cell SRE-LMS equalizer receiver of FIG. 4 in terms of the process of performing multi-cell channel estimation, calculating an equalizer FIR filter's tap coefficient by means of the multi-cell equalizer adaptation unit 440, and then performing an equalizer reception process. However, the multi-cell reference signal reconstructor 710 generates a non-orthogonal reference signal 711 such as the serving cell's SCH and the other cells' SCH and CPICH, and provides the generated reference signal 711 to the reference signal interference canceller 720, the reference signal interference canceller 720 cancels the non-orthogonal reference signal 711 from the data signal 151 which is to be applied to the equalizer FIR filter 170 after passing through the chip buffer 150, and then the equalizer FIR filter 170 performs the equalizer reception process, thereby improving performance of received signals.

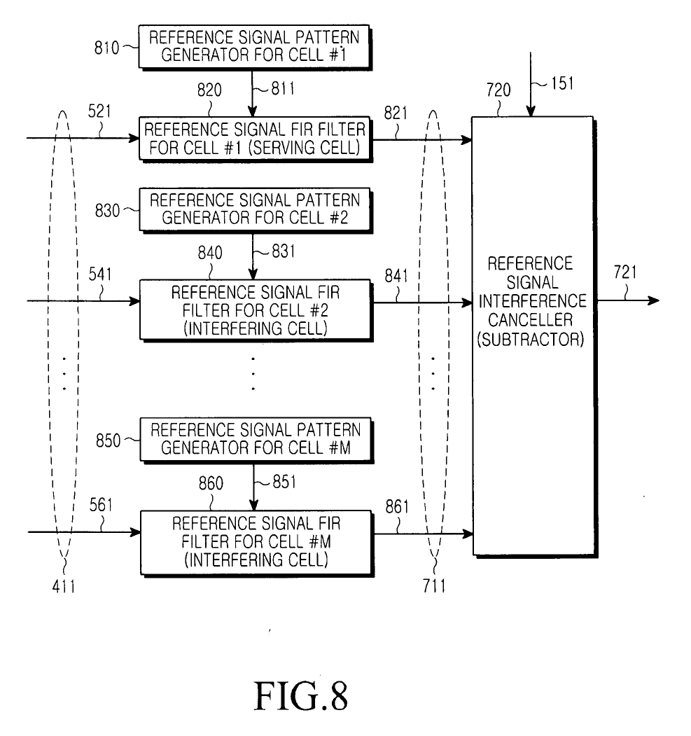

FIG. 8 illustrates detailed structures of the multi-cell reference signal reconstructor 710 and the reference signal interference canceller 720.

The reference signal interference canceller 720 is a circuit for improving the quality of received signals by reconstructing multi-cell reference signals in a physical layer and cancelling them from the data signal 151. The signals to be cancelled by the reference signal interference canceller 720 are reference signals, inter-channel orthogonality of which is not maintained and pattern generation for which is possible in the physical layer.

The complexity and processing time of the reference signal interference canceller can be significantly reduced by dealing with the signals, pattern generation for which and detection of which are possible in the physical layer, without performing interference cancellation on the signals, detection of which and pattern generation for which are possible in a higher layer.

These reference signals being subject to interference cancellation correspond to the serving cells SCH and the other cells' SCH and CPICH, in WCDMA and HSPA systems.

The SCH, a channel consisting of Primary SCH (P-SCH) and a Secondary SCH (S-SCH), is a reference signal that is used for the purpose of cell searching and can be generated in the physical layer. Since the SCH is transmitted without being spread with an orthogonal code in a base station, both the serving cell's SCH signal and the other cells' SCH signals serve as interference in a receiver.

The CPICH, carrying a Primary CPICH (P-CPICH) and a Secondary CPICH (S-CPICH), is a reference signal that is used for the purpose of channel estimation and can be generated in the physical layer. Since the CPICH signal is transmitted after being spread with an orthogonal code in a base station, the serving cell's CPICH signal does not serve as interference. However, because the other cells' CPICH signals are not consistent in inter-cell timing synchronization, these signals eventually serve as interference unless cancelled in a despreading process of the receiver.

A first-cell reference signal pattern generator (or a reference signal pattern generator for a first cell) 810 generates a serving cell's reference signal 811 and provides it to a first-cell reference signal FIR filter (or a reference signal FIR filter for a first cell) 820. In the WCDMA and HSPA systems, the reference signal 811 becomes an SCH signal pattern. The first-cell reference signal FIR filter 820, an FIR filter using a first-cell multi-tap channel estimation value 521 as a tap coefficient, filters the reference signal pattern 811 and outputs the result. Therefore, an output signal 821 is reconstructed as almost the same signal as the first cell's reference signal that has arrived at the receiver passing through the channel.

A second-cell reference signal pattern generator (or a reference signal pattern generator for a second cell) 830 generates a reference signal 831 of the second cell, which is an interfering cell. In the WCDMA and HSPA system, the reference signal 831 becomes SCH and CPICH signal patterns. A second-cell reference signal FIR filter (or a reference signal FIR filter for a second cell) 840, an FIR filter using a second-cell multi-tap channel estimation value 541 as a tap coefficient, filters the reference signal 831 and outputs the result. Thus, an output signal 841 is reconstructed as almost the same signal as the second cell's reference signal that has arrived at the receiver passing through the channel.

An M-th-cell reference signal pattern generator (or a reference signal pattern generator for an M-th cell) 850 generates a reference signal 851 of the M-th cell, which is an interfering cell. As in the second cell, the reference signal 851 of the M-th cell becomes SCH and CPICH signal patterns. An M-th-cell reference signal FIR filter (or a reference signal FIR filter for an M-th cell) 860, an FIR filter using an M-th-cell multi-tap channel estimation value 561 as a tap coefficient, filters the reference signal 851 and outputs the result. Thus, an output signal 861 is reconstructed as almost the same signal as the M-th cell's reference signal that has arrived at the receiver passing through the channel.

A reference signal interference canceller 720 is a circuit for cancelling the reconstructed multi-cell reference signals 821, 841 and 861 from the received data signal 151, and it can be realized with a subtractor.

Strength of a received signal from each cell has already been reflected by each of multi-cell channel estimation values, and a reference signal pattern generator should be present for each cell. A reference signal pattern generator and a reference signal interference canceller for each cell operate depending on timing information received from the multi-cell timing & interference canceller control unit 730.

Since the multi-cell reference signal interference cancellation equalizer receiver according to an embodiment of the present invention reconstructs only the reference signals, which can be generated in the physical layer, the proposed receiver is superior in complexity to the structure requiring a detection block, like the Multi-User Detection (MUD) interference cancellation scheme.

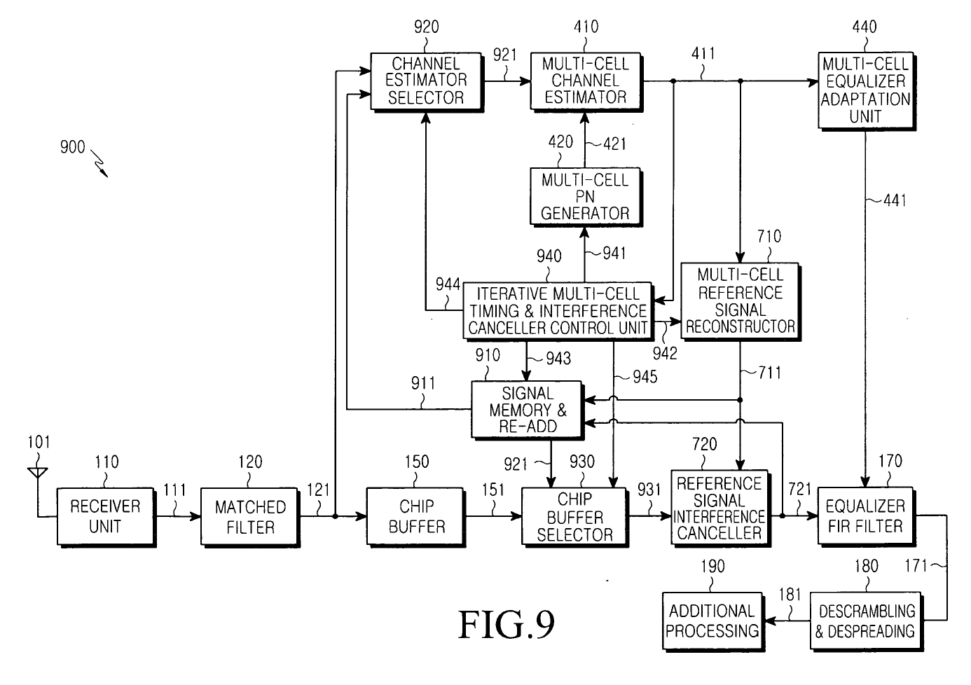

FIG. 9 illustrates a structure of an iterative multi-cell reference signal interference cancellation SRE-LMS equalizer receiver (or an equalizer receiver with iterative multi-cell SRE-LMS and reference signal cancellation).

The iterative multi-cell reference signal interference cancellation SRE-LMS equalizer receiver 900 of FIG. 9 is different from the multi-cell reference signal interference cancellation SRE-LMS equalizer receiver 700 of FIG. 7 in that a signal memory & re-adder 910, a channel estimator selector 920 and a chip buffer selector 930 are added, and an iterative multi-cell timing & interference canceller control unit 940 is modified. The added and modified components are components for improving performance of the receiver by performing the above-described multi-cell SRE-LMS and multi-cell interference cancellation method several times in an iterative method if necessary.

The signal memory & re-adder 910 is a memory circuit that has stored a signal 721, from which interference was cancelled by the reference signal interference canceller 720, and then iteratively re-applies the signal.

The channel estimator selector 920 and the chip buffer selector 930 are circuits for performing input selection between the data signal 121 initially including interference and a signal 911 which has been stored in the memory after interference was canceled therefrom during iteration.

The iterative multi-cell timing & interference canceller control unit 940 generates timings of an initial operation and iterative operations and managing the timings.

A one-time operation with no iteration or a first one operation of an iterative operation is the same as that of FIG. 7. In other words, if an iteration number (or the number of iterations) is 1, an operation in FIG. 9 is the same as the operation of FIG. 7, regardless of the components added or modified in FIG. 9, compared with FIG. 7.

Now, an example of an operation with an iteration number=2 will be described.

In a first iteration, the channel estimator selector 920 provides the output 121 of the matched filter 120 to the multi-cell channel estimator 410. The chip buffer selector 930 provides the output 151 of the chip buffer 150 to the reference signal interference canceller 720. The reference signal interference canceller 720 outputs the signal 721 from which the interference received from the multi-cell reference signal reconstructor 710 is canceled, and the signal 721 is provided to the signal memory & re-adder 910, without being directly provided to the equalizer FIR filter 170. The signal memory & re-adder 910 receives even the reconstructed reference signals 821, 841 and 861 for respective cells, generated by the multi-cell reference signal reconstructor 710, and stores all the received signals.

In a second iteration, the channel estimator selector 920 provides the output signal 911 of the signal memory & re-adder 910 to the multi-cell channel estimator 410, and the chip buffer selector 930 provides an output signal 912 of the signal memory & re-adder 910 to the reference signal interference canceller 720. As a result, the multi-cell channel estimator 410 outputs the channel estimation value 411, performance of which is improved using the signal with reference signal interference cancelled. Accordingly, the multi-cell equalizer adaptation unit 440 may output a more accurate equalizer FIR filter's tap coefficient 441. The reference signal interference canceller 720 may further cancel residual interference if necessary, or may provide the output signal 721 to the equalizer FIR filter 170 without additional interference cancellation, if the interference was already cancelled in first iteration.

If the iteration number is set to a plural number, the iteration operation may be performed several times, and the operations are controlled by the iterative multi-cell timing & interference canceller control unit 940.

Since the iterative multi-cell reference signal interference cancellation equalizer receiver according to an exemplary embodiment of the present invention iteratively cancels only the reference signal interference which can be generated in the physical layer, the proposed receiver is superior to the MUD interference cancellation scheme requiring a detection block in terms of complexity and processing delay.

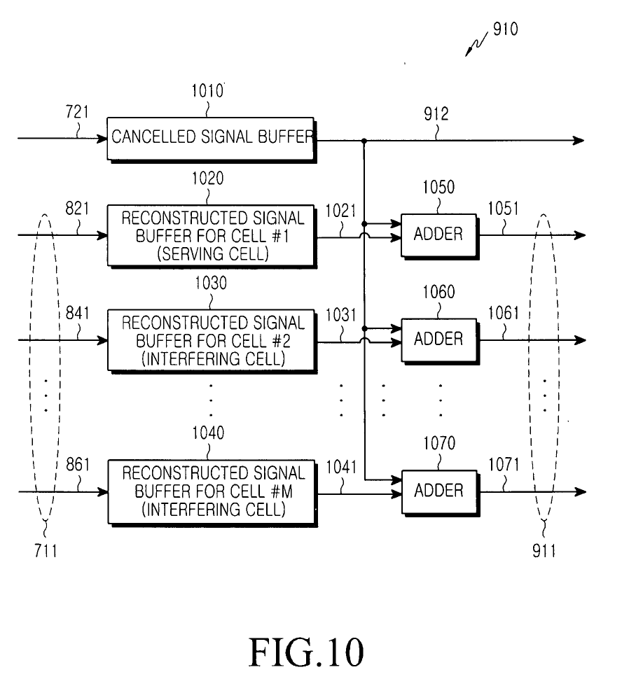

FIG. 10 illustrates a structure of a signal memory & re-adder according to an embodiment of the present invention.

The signal memory & re-adder 910 is a circuit serving as a memory that has stored the interference-cancelled signal during previous iteration and re-applies the stored signal to an associated block in the next iteration, when iteratively performing reference signal interference cancellation.

A cancelled signal buffer 1010 has stored an interference-cancelled signal 721 from the reference signal interference canceller 720, and re-outputs the stored signal during next iteration. The re-output signals 912 are re-applied not only to the chip buffer selector 930, but also to adders 1050, 1060 and 1070. Reference numerals 1020, 1030 and 1040 represent reconstructed signal buffers for a first cell, a second cell and an M-th cell, respectively. These buffers store the reconstructed signals 821, 841 and 861 generated by the reference signal FIR filters 820, 840 and 860 of FIG. 8, respectively.

The reason for re-buffering the reconstructed signals is that as for the output signals 912 of the cancelled signal buffer 1010, all reference signals such as SCH and CPICH have already been cancelled therefrom, and if the receiver re-applies the output signals 1011 and 912 to the channel estimator 410 to perform reference signal-based channel estimation, the channel estimator 410 cannot perform accurate channel estimation. Therefore, the reconstructed reference signals 821, 841 and 861 for associated cells have been stored in the reconstructed signal buffers 1020, 1030 and 1040 for associated cells, respectively, and are re-added to the signals 911 being re-applied to the channel estimator 410, respectively, thereby facilitating a normal channel estimation operation.

A signal 1021, which has been stored in the first-cell reconstructed signal buffer 1020, is added to the output 1011 of the cancelled signal buffer 1010, becoming a signal 1051, which may be provided to a first-cell channel estimator. In the same manner, a signal 1031, which has been stored in a second-cell reconstructed signal buffer 1030, is added to the output 1011 of the cancelled signal buffer 1010, becoming a signal 1061, which may be provided to a second-cell channel estimator. A signal 1041, which has been stored in an M-th-cell reconstructed signal buffer 1040, is added to the output 1011 of the cancelled signal buffer 1010, becoming a signal 1071, which may be provided to an M-th-cell channel estimator.

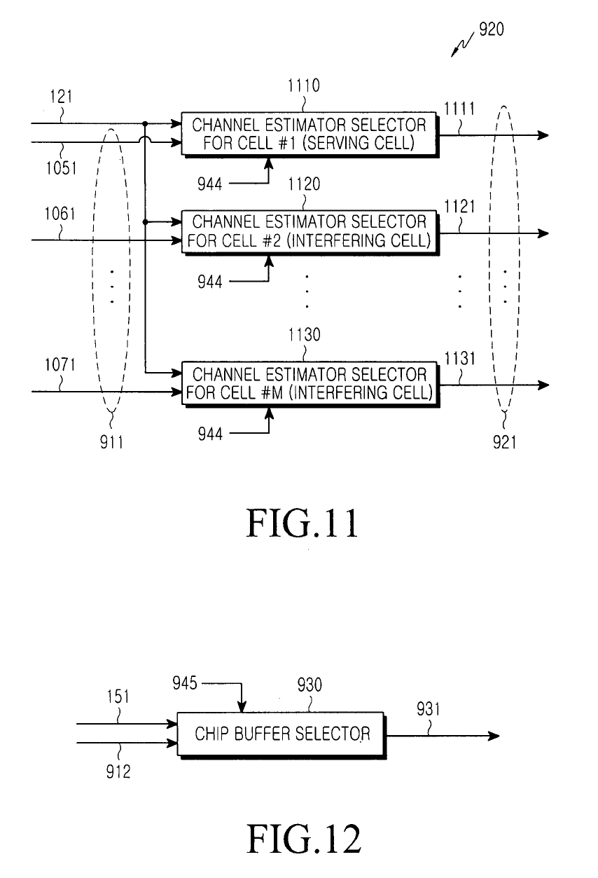

FIG. 11 illustrates a structure of a channel estimator selector.

The channel estimator selector 920 is a circuit that provides the intact output 121 of the matched filter 120 to the multi-cell channel estimator 410 in the case of a one-time operation with no iteration or a first one operation of an iterative operation, and provides the signal 911 received from the signal memory & re-adder 910 to the multi-cell channel estimator 410 in the case of a second or more operation of an iterative operation.

A first-cell channel estimator selector (or a channel estimator selector for a first cell) 1110 is a circuit outputs a signal 921 which is one of inputs 121 and 1051. In the same manner, a second-cell channel estimator selector (or a channel estimator selector for a second cell) 1120 is a circuit that selects and outputs a signal 921 which is one of inputs 121 and 1061, and an M-th-cell channel estimator selector (or a channel estimator for an M-th cell) 1130 is a circuit that selects and outputs a signal 921 which is one of inputs 121 and 1071. This input/output selection is controlled by an input signal 944 received from the iterative multi-cell timing & interference canceller control unit 940.

FIG. 12 illustrates a structure of a chip buffer selector.

A chip buffer selector 930 is a circuit that provides a signal 931 which is the intact output 151 of the chip buffer 150 to the reference signal interference canceller 720 in the case of a one-time operation with no iteration or a first one operation of an iterative operation, or the signal 912 received from the signal memory & re-adder 910 to the reference signal interference canceller 720 in the case of a second or more operation of an iterative operation. This input/output selection is controlled by an input signal 945 received from the iterative multi-cell timing & interference canceller control unit 940.

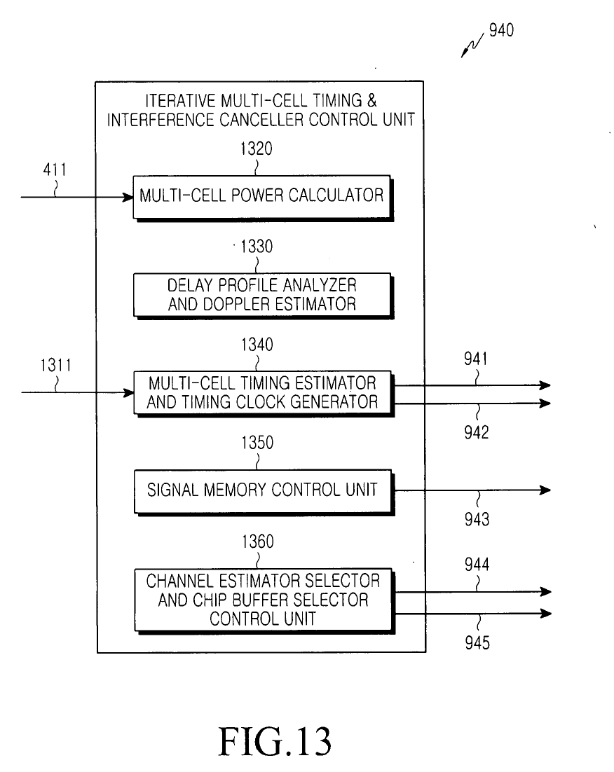

FIG. 13 illustrates the structure and signal flow of an iterative multi-cell timing & interference canceller control unit.

An exemplary embodiment of the present invention includes a control circuit for adaptively activating/inactivating multi-cell equalizer adaptation and multi-cell reference signal interference cancellation functions by determining strengths of multi-cell signals through power estimation for multi-cell received signals, and estimates and compensates accurate operation phases and edges for multiple cells through time tracking.

The iterative multi-cell timing & interference canceller control unit 940 includes a multi-cell power calculator 1320, a delay profile analyzer and Doppler estimator 1330, a multi-cell timing estimator and timing clock generator 1340, a signal memory control unit 1350, and a channel estimator selector and chip buffer selector control unit 1360.

The multi-cell power calculator 1320 receives multi-cell channel estimation value 411, and calculates received power for each cell and each tap.

The delay profile analyzer and Doppler estimator 1330 estimates a multi-path delay profile of a received channel based on the calculated received power, estimates a moving speed of a receiving terminal, and generates important information to be used for receiver's time tracking.

The multi-cell timing estimator and timing clock generator 1340 estimates operation phases and timings of the multi-cell channel estimator 410 and the multi-cell interference signal cancellation blocks 710 and 720, using the received power for each cell and each tap, calculated from the channel estimation value, and the multi-path delay profile. The multi-cell timing estimator and timing clock generator 1340 may receive cell phase information 1311 of a cell searcher (not shown) or a higher layer and use it for timing generation in a particular situation such as initial setup and reconfiguration. The multi-cell timing estimator and timing clock generator 1340 controls operation phases and timings of the multi-cell channel estimator 410 and the multi-cell interference signal cancellation blocks 710 and 720. Herein, a signal 941 is timing information for an operation of the multi-cell channel estimator 410, and a signal 942 includes operation timing information and/or canceller operation control information of the multi-cell interference signal cancellation blocks 710 and 720. The canceller operation control information of the multi-cell interference signal cancellation blocks 710 and 720 includes control information for comparing received power of each cell and activating/inactivating a reference signal canceller for each cell if necessary.

The signal memory control unit 1350 is a circuit that controls buffering and signal output timing of the signal memory & re-adder 910.

The channel estimator selector and chip buffer selector control unit 1360 is a circuit for generating an output signal 944 that controls input/output selection of the channel estimator selector 920, and an output signal 945 that controls input/output selection of the chip buffer selector 930.

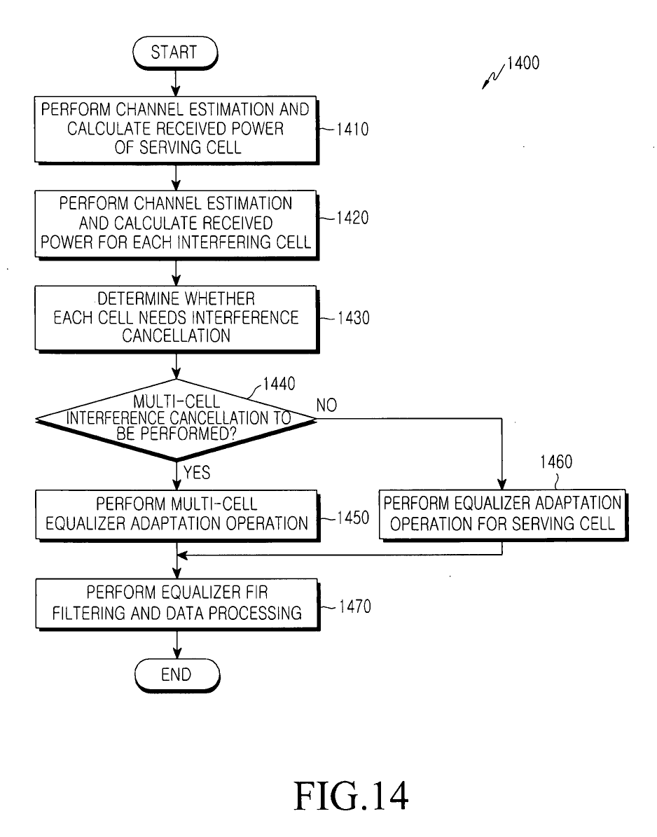

FIG. 14 illustrates an operation of a multi-cell SRE-LMS equalizer receiver (or an equalizer receiver with multi-cell signal SRE-LMS) according to an embodiment of the present invention.

The receiver of the present invention performs multi-cell multi-tap channel estimation and calculates received power of each cell through blocks 1410 and 1420. The received power of each cell can be calculated by Equation 1:

$${P}_{j} = {\sum }_{i = 1}^{N} \vert {CE}_{i , j} \vert \qquad [ Eqn . 1 ]$$

where Pⱼ denotes received cell power of a j-th cell, for j=1, 2, . . . , M. Here, j=1 indicates a serving cell (or own cell), and indicates other cells (or non-serving cells). CE_{i,j} denotes a channel estimation value of an i-th tap for a j-th cell, and N denotes the number of taps of a multi-tap channel estimator. If received power of each cell is calculated, the receiver compares the other cell's power with a particular threshold in block 1430. If the other cell's power is greater than the threshold, the receiver determines the other cell as a cell for which it will perform interference cancellation. If the other cell's power is less than or equal to the threshold, the receiver determines the other cell as a cell for which it will not perform interference cancellation. Block 1430 can be represented by Equation 2:

$$\begin{matrix}Cancellation for \\ Non \text{-} Servicing Cell \# j\end{matrix} = \{ \begin{matrix}ON , & if {P}_{j} > {T}_{IC} \\ OFF , & otherwise\end{matrix} \qquad [ Eqn . 2 ]$$

where T_{IC} denotes a threshold for cancellation, and can be generated by a product of the serving cell's power and a tuning constant α as defined by Equation 3. α is a value between 0 and 1, and can be differently set depending on a receive rate of a terminal and a fading channel environment.

T_{IC}=α·P₁ [Eqn. 3]

After ON or OFF operation of interference cancellation for each cell is determined, the receiver determines in block 1440 whether it will perform multi-cell interference cancellation. If there is any other cell for which interference cancellation is to be performed, the receiver performs a multi-cell equalizer adaptation operation in block 1450. If there is no other cell for which interference cancellation is to be performed, the receiver performs an equalizer adaptation operation only for the serving cell in block 1460. If a tap coefficient of an equalizer FIR filter is determined through equalizer adaptation, the receiver performs equalizer FIR filtering and data processing in block 1470.

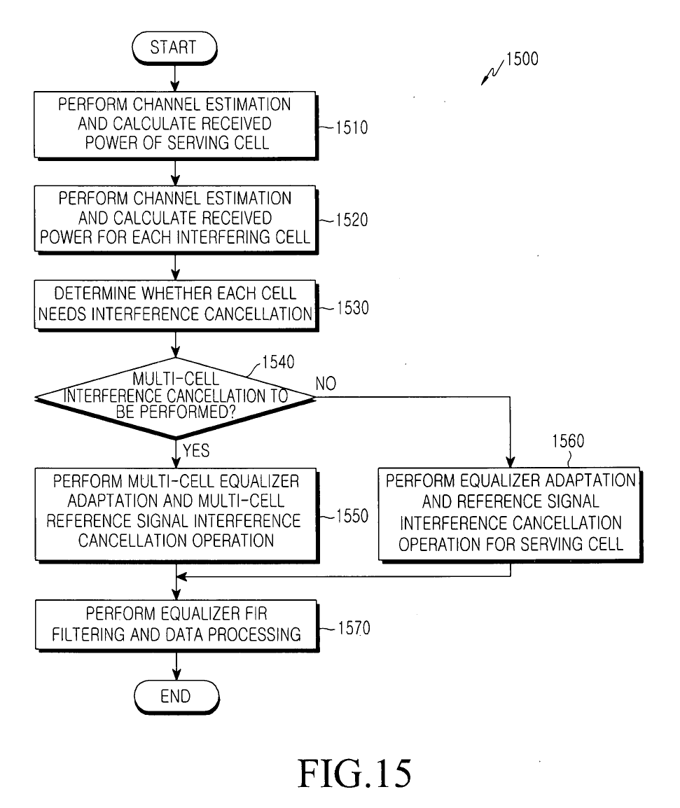

FIG. 15 illustrates an operation of a multi-cell reference signal interference cancellation SRE-LMS equalizer receiver (or an equalizer receiver with multi-cell signal SRE-LMS and reference signal cancellation) according to an embodiment of the present invention.

The multi-cell reference signal interference cancellation SRE-LMS equalizer receiver of FIG. 15 is different from the multi-cell SRE-LMS equalizer receiver of FIG. 14 in that reconstruction and interference cancellation functions for multi-cell reference signal interference are additionally performed. Therefore, the basic operational sequence is the same as that of FIG. 14, but the multi-cell reference signal interference cancellation SRE-LMS equalizer receiver determines in block 1540 whether it will perform multi-cell interference cancellation. If there is any other cell being subject to interference cancellation, the receiver performs multi-cell equalizer adaptation and multi-cell reference signal interference cancellation operations in block 1550. However, if there is no other cell being subject to interference cancellation, the multi-cell reference signal interference cancellation SRE-LMS equalizer receiver performs equalizer adaptation and reference signal interference cancellation operations only for the serving cell in block 1560. If an equalizer FIR filter's tap coefficient is determined through the equalizer adaptation, equalizer FIR filtering and data processing are performed in block 1570.

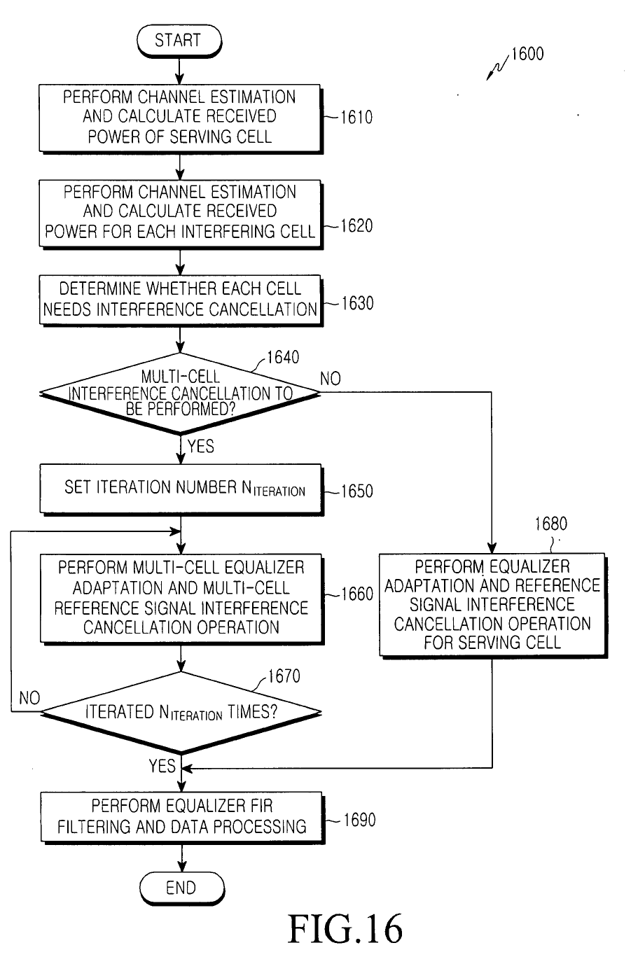

FIG. 16 illustrates an operation of an iterative multi-cell reference signal interference cancellation SRE-LMS equalizer receiver (or an equalizer receiver with iterative multi-cell signal SRE-LMS and reference signal cancellation) according to an embodiment of the present invention.

The iterative multi-cell reference signal interference cancellation SRE-LMS equalizer receiver of FIG. 16 is different from the multi-cell reference signal interference cancellation SRE-LMS equalizer receiver of FIG. 15 in that iterative SRE-LMS and reference signal interference cancellation functions are added. If the iteration number is determined as 1, the iterative multi-cell reference signal interference cancellation SRE-LMS equalizer receiver is the same in operation as the multi-cell reference signal interference cancellation SRE-LMS equalizer receiver of FIG. 15. However, if the iteration number is determined as 2 or more, the iteration multi-cell reference signal interference cancellation SRE-LMS equalizer receiver determines in block 1640 whether it will perform multi-cell interference cancellation. If there is any other cell being subject to interference cancellation, the receiver sets the iteration number in block 1650, and then performs multi-cell equalizer adaptation and multi-cell reference signal interference cancellation operations in block 1660. The iterative multi-cell reference signal interference cancellation SRE-LMS equalizer receiver checks the number of iterations in block 1670. If the number of iterations is not greater than or equal to the set iteration number, the receiver repeats block 1660. If the number of iterations is greater than or equal to the set iteration number, equalizer FIR filtering and data processing are performed in block 1690. To be sure, if there is no other cell being subject to interference cancellation in block 1640, the iterative multi-cell reference signal interference cancellation SRE-LMS equalizer receiver performs equalizer adaptation and reference signal interference cancellation operations only for the serving cell in block 1680.

As is apparent from the foregoing description, the receiver according to exemplary embodiments of the present invention uses multi-cell equalizer adaptation and multi-cell reference signal interference cancellation in an environment where multi-cell signals are received, such as cell edges, facilitating high-speed reception without performance loss due to the environment where multi-cell signals are received. In addition, during iterative equalizer adaptation and interference cancellation, the receiver's channel estimation performance and equalizer adaptation performance can be maximized by buffering and re-applying interference-cancelled signals.

Furthermore, the present invention can adaptively activate/inactivate multi-cell equalizer adaptation and multi-cell reference signal interference cancellation functions by determining strengths of multi-cell signals through power measurement for multi-cell received signals, and can estimate accurate operation phases and edges of multiple cells through time tracking. Therefore, the present invention enables a receiving terminal to determine by itself whether it is located in a reception environment where multi-cell signals are received, such as cell edges, and based thereon, use multi-cell equalizer adaptation and multi-cell reference signal interference cancellation, thereby eliminating the performance loss the conventional receivers experience, and enabling high-speed reception.

Besides, the receiver with a multi-cell adaptive equalizer according to an embodiment of the present invention can be realized if there are only two different types of information: ID and timing boundary of a cell-specific PN code. The receiver deals with the signals, pattern generation for which and detection of which are possible in the physical layer, without performing interference cancellation on the signals, detection of which and pattern generation for which are possible in the higher layer, thereby significantly reducing complexity and processing time of the interference cancellation circuit.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for receiving a signal using an equalizer receiver in a mobile communication system, the method comprising:
matched-filtering a signal received via an antenna;
generating different phase information for a serving cell and one or more other cells;
generating Pseudo-random Noise (PN) codes for the cells based on the phase information;
estimating channel estimation values for the cells using the PN codes and the filtered signal;
modeling random sequences similar in statistical property to signals transmitted from the cells using the channel estimation values, and generating a filter coefficient using the modeled random sequences; and
equalizing the filtered signal using the filter coefficient.

2. The method of claim 1, wherein modeling random sequences comprises reconstructing a random sequence similar in statistical property to a transmission signal of the serving cell, reconstructing random sequences similar in statistical property to received signals from the cells with the channel estimation values, and generating the filter coefficient by receiving the reconstructed signals.

3. The method of claim 1, further comprising:
reconstructing one or more interference signals using channel estimation values corresponding to the cells; and
cancelling the reconstructed interference signals from the filtered signal, before equalizing the filtered signal.

4. The method of claim 3, further comprising:
storing the reconstructed interference signals and signals from which the interference signals are cancelled;
adding the stored interference signals and the signals from which the interference signals are cancelled; and
iterating estimating channel estimation values for the cells using the PN codes and the filtered signal, reconstructing one or more interference signals using channel estimation values corresponding to the cells and cancelling the reconstructed interference signals from the filtered signal as many times as a predetermined iteration number using the added signals;
wherein during the iteration, the reconstructed reference signals are canceled from the signals from which the interference signals are cancelled.

5. The method of claim 3, further comprising determining a cell having received power greater than a predetermined specific value, among the one or more other cells, as a cell for which the interference signal is to be reconstructed.

6. The method of claim 5, wherein the specific value is a product of a received power of the serving cell and a tuning constant.

7. The method of claim 3, wherein each of the reconstructed interference signals includes at least one of a Synchronization Channel (SCH) signal of the serving cell, SCH signals of the one or more other cells, and Common Pilot Channel (CPICH) signals of the one or more other cells.

8. The method of claim 1, wherein the different phase information is generated using Identifier (ID) and timing boundary information of each cell.

9. An equalizer receiver for receiving a signal in a mobile communication system, the equalizer receiver comprising:
a matched filter configured to matched-filter a signal received via an antenna;
a control unit configured to generate different phase information for a serving cell and one or more other cells;
a multi-cell Pseudo-random Noise (PN) generator configured to generate PN codes for the cells based on the phase information;
a multi-cell channel estimator configured to estimate channel estimation values for the cells using the PN codes and the filtered signal;
a multi-cell adaptive equalizer configured to model random sequences similar in statistical property to signals transmitted from the cells using the channel estimation values, and generating a filter coefficient using the modeled random sequences; and
an equalizer Finite Impulse Response (FIR) filter configured to equalize the filtered signal using the filter coefficient.

10. The equalizer receiver of claim 9, wherein the multi-cell adaptive equalizer comprises:
a random sequence generator configured to output a random sequence similar in statistical property to a transmission signal of the serving cell; and
a signal reconstruct filter for each cell configured to output a random sequence similar in statistical property to received signals from the cells using the channel estimation values, and generate a filter coefficient by receiving an output of the random sequence generator and an output of the signal reconstruct filter for each cell.

11. The equalizer receiver of claim 9, further comprising:
a reference signal reconstructor configured to reconstruct interference signals using the channel estimation values; and
a reference signal interference canceller configured to cancel the reconstructed interference signals from the filtered signal before the filtered signal is input to the equalizer FIR filter.

12. The equalizer receiver of claim 11, further comprising a signal memory and re-adder configured to:
store the reconstructed interference signals and signals from which the interference signals are cancelled, and add the stored interference signals and the signals from which the interference signals are cancelled; and
iteratively re-apply the added signals to the multi-cell channel estimator as many times as a predetermined iteration number.

13. The equalizer receiver of claim 12, wherein each of the interference signals reconstructed by the reference signal reconstructor includes at least one of a Synchronization Channel (SCH) signal of the serving cell, SCH signals of the one or more other cells, and Common Pilot Channel (CPICH) signals of the one or more other cells.

14. The equalizer receiver of claim 11, wherein the control unit is configured to determine a cell having received power greater than a predetermined specific value, among the one or more other cells, as a cell for which the interference signal is to be reconstructed.

15. The equalizer receiver of claim 14, wherein the specific value is a product of a received power of the serving cell and a tuning constant.

16. The equalizer receiver of claim 9, wherein the control unit is configured to generate the different phase information using Identifier (ID) and timing boundary information of each cell.

17. A wireless communications device comprising:
an equalizer receiver configured to receiving a signal in a mobile communication system, the equalizer receiver comprising:
a matched filter configured to matched-filter a signal received via an antenna;
a control unit configured to generate different phase information for a serving cell and one or more other cells;
a multi-cell Pseudo-random Noise (PN) generator configured to generate PN codes for the cells based on the phase information;
a multi-cell channel estimator configured to estimate channel estimation values for the cells using the PN codes and the filtered signal;
a multi-cell adaptive equalizer configured to model random sequences similar in statistical property to signals transmitted from the cells using the channel estimation values, and generating a filter coefficient using the modeled random sequences; and
an equalizer Finite Impulse Response (FIR) filter configured to equalize the filtered signal using the filter coefficient.

18. The wireless communications device of claim 17, wherein the multi-cell adaptive equalizer comprises:
a random sequence generator configured to output a random sequence similar in statistical property to a transmission signal of the serving cell; and
a signal reconstruct filter for each cell configured to output a random sequence similar in statistical property to received signals from the cells using the channel estimation values, and generate a filter coefficient by receiving an output of the random sequence generator and an output of the signal reconstruct filter for each cell.

19. The wireless communications device of claim 17, further comprising:
a reference signal reconstructor configured to reconstruct interference signals using the channel estimation values; and
a reference signal interference canceller configured to cancel the reconstructed interference signals from the filtered signal before the filtered signal is input to the equalizer FIR filter.

20. The wireless communications device of claim 19, further comprising a signal memory and re-adder configured to:
store the reconstructed interference signals and signals from which the interference signals are cancelled, and add the stored interference signals and the signals from which the interference signals are cancelled; and
iteratively re-apply the added signals to the multi-cell channel estimator as many times as a predetermined iteration number.

21. The wireless communications device of claim 20, wherein each of the interference signals reconstructed by the reference signal reconstructor includes at least one of a Synchronization Channel (SCH) signal of the serving cell, SCH signals of the one or more other cells, and Common Pilot Channel (CPICH) signals of the one or more other cells.

22. The wireless communications device of claim 19, wherein the control unit is configured to determine a cell having received power greater than a predetermined specific value, among the one or more other cells, as a cell for which the interference signal is to be reconstructed.

23. The wireless communications device of claim 22, wherein the specific value is a product of a received power of the serving cell and a tuning constant.

24. The wireless communications device of claim 17, wherein the control unit is configured to generate the different phase information using Identifier (ID) and timing boundary information of each cell.
